(19) United States
(12) Patent Application Publication
(10) Pub. No.: US 2025/0182310 A1
(43) Pub. Date: Jun. 5, 2025

(54) FOVEATED IMAGING BASED ON MACHINE LEARNING MODELING OF DEPTH MAPPING

(71) Applicant: Meta Platforms Technologies, LLC, Menlo Park, CA (US)

(72) Inventors: Sebastian Sztuk, Virum (DK); Alex Locher, Oberrohrdorf (CH); Nenad Zivic, Zurich (CH); Robert Kristian Thiel, Niederstaufen (DE); Rakesh Ranjan, Mountain View, CA (US); Andrey Tovchigrechko, Saratoga, CA (US)

(21) Appl. No.: 18/968,445

(22) Filed: Dec. 4, 2024

Related U.S. Application Data
(60) Provisional application No. 63/606,011, filed on Dec. 4, 2023.

(51) Int. Cl. G06T 7/55; G06F 3/01; G06V 10/25

(52) U.S. Cl. CPC G06T 7/55; G06F 3/013; G06V 10/25

(57) ABSTRACT

The subject disclosure provides for systems and methods for generating a dense depth map. The method may include determining a first region of interest via input from a first sensor device configured to capture supplemental pixel images. The method may include determining a second region of interest via input from a second sensor device configured to capture supplemental pixel images. The method may include receiving depth measurements from a third sensor device configured to capture depth measurements. The method may include determining a plurality of depth maps from the pixel images from the first sensor device, the supplemental pixel images from the second sensor device, and the depth measurements from the third sensor device. The method may include generating from the plurality of depth maps a foveated region comprising a high-resolution image and a low-resolution image oriented on the periphery of the foveated region.

### CROSS RELATED APPLICATIONS

The present disclosure is related and claims priority under 35 U.S.C. 119(e) to U.S. Provisional Patent Application No. 63/606,011 filed on Dec. 4, 2023, the disclosure of which is hereby incorporated by reference in its entirety for all purposes.

### TECHNICAL FIELD

The present disclosure generally relates to imaging in an augmented/virtual reality (AR/VR) system, and more particularly to a depth sensing enhancement in the AR/VR system.

### BACKGROUND

Current machine learning depth systems use an evenly distributed low-resolution capture of an entire scene, in order to build a depth map of the users' environment applications. By reconstructing the depth at the same resolution in the entire field of view (FoV) all the time, the system can spend excessive power and computing resources. These computing resources may be required to optimize: resolution (e.g., high resolution vs. low resolution), frame rate (e.g., 24, 30 or 60 frames per second); and detail (e.g., texture, lighting draw distance and other effects). In addition, depth information is a key performance indicator (KPI) for an MR environment. To generate a “fluid” experience, displays need to be refreshed with at least 60 hz. Other refresh rates of 72 hz, 90 hz or 120 hz are common as well. To refresh the displays at 60 hz in MR, the depth maps need to be used for two consecutive frames.

### BRIEF SUMMARY

The subject disclosure provides for systems and methods for generating dense depth maps. One aspect of the present disclosure relates to a method for generating the dense depth maps. The method may include determining a first region of interest via input from a first sensor device. The first sensor device is configured to capture pixel images. The method can include implementing a depth sensing model. The depth sensing model can be configured to determine depth measurements based on the captured pixel images. The method can include generating from the plurality of depth maps a foveated region comprising a high-resolution image and a low-resolution image oriented on the periphery of the foveated region.

One aspect of the present disclosure relates to a system for generating dense depth maps. The system may include one or more hardware processors configured by machine-readable instructions. The processor(s) may be configured to determine a first region of interest via input from a first sensor device configured to capture pixel images. The processor(s) may be configured to determine a second region of interest via input from a second sensor device configured to capture supplemental pixel images. The processor(s) may be configured to receive depth measurements from a third sensor device configured to capture depth measurements. The processor(s) may be configured to determine a plurality of depth maps from the pixel images from the first sensor device, the supplemental pixel images from the second sensor device, and the depth measurements from the third sensor device. The processor(s) may be configured to determine a plurality of depth maps from the pixel images from the first sensor device, the supplemental pixel images from the second sensor device, and the depth measurements from the third sensor device. The processor(s) may be configured to generate from the plurality of depth maps a foveated region comprising a high-resolution image and a low-resolution image oriented on the periphery of the foveated region.

Yet another aspect of the present disclosure relates to a non-transient computer-readable storage medium having instructions embodied thereon, the instructions being executable by one or more processors to perform a method for generating a dense depth map. The method may include determining a first region of interest via input from a first sensor device configured to capture pixel images. The method may include determining a second region of interest via input from a second sensor device configured to capture supplemental pixel images. The method may include receiving depth measurements from a third sensor device configured to capture depth measurements. The method may include determining a plurality of depth maps from the pixel images from the first sensor device, the supplemental pixel images from the second sensor device, and the depth measurements from the third sensor device. The method may include generating from the plurality of depth maps a foveated region comprising a high-resolution image and a low-resolution image oriented on the periphery of the foveated region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example arrangement of cameras to identify a region of interest.

FIG. 2 illustrates an example arrangement of cameras to identify perspectives while implementing a direct Time of Flight (dToF) view sensor.

FIG. 3 illustrates a simulation of a foveated arrangement of an image.

FIG. 4 illustrates a system configured for generating a dense depth map, in accordance with one or more implementations.

FIG. 5 illustrates a method for generating a dense depth map, in accordance with one or more implementations.

FIG. 6 illustrates an alternative method for generating a dense depth map, in accordance with one or more implementations.

FIG. 7 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments of the disclosed technology may include or be implemented in conjunction with an artificial reality system. Artificial reality, extended reality, or extra reality (collectively “XR”) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, an MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Heads-up displays (HUDs) and/or head mounted displays (HMDs) have demonstrated the importance of eye tracking (ET) by enabling use cases like ET driven Foveated Rendering (ETFR). Current ET sensors are glint-based solutions using camera and multiple LEDs as the hardware platform, and the software pipeline (hereafter referred to as “ET 1.0”) may rely on both computer vision and machine learning algorithms for gaze angle calculation. The main drawback from higher resolution depth is power, where gaze based foveation will help enable that only the object of interest has a high-resolution depth map. In another aspect, the gaze angle calculations can be determined by cameras mounted externally to the headset that also capture images, such as RGB images.

The current disclosures may use depth from stereo RGB images, and fuse the stereo RGB images with depth sensor information, such as direct time-of-flight (dToF) sensor information. The human eyes cover a very large (>180 deg) FOV, but only the central +/−30 deg around the gaze angle is seen in full fidelity. This disclosure implements an ML depth system based on the user's attention, using the x-y gaze and vergence data from an eye tracking system in the head mounted display. The current ML depth model can be a stereo disparity estimator that takes as input a stereo pair of grayscale images from front-facing cameras and outputs per-eye dense maps of disparities, which can then be converted to dense depth maps through triangulation. The model can be trained on a large diverse dataset consisting of a combination of real and synthetic data from the target sensor system. The dense depth maps can then be fed to and consumed by multiple downstream mixed reality features, such as passthrough, dynamic occlusions, boundary defining parameters. In an aspect, a processor such as a graphics processing unit (GPU) can align objects in real space with objects in the virtual space and define a space setup, which orients the interactive area of the virtual reality space. These features have different requirements, so the model aims to achieve a healthy balance between high resolution (currently QVGA, aiming for VGA), high frequency (currently 30 Hz) and good near and far range accuracy, while staying lightweight and meeting the computing constraints of today's VR headsets.

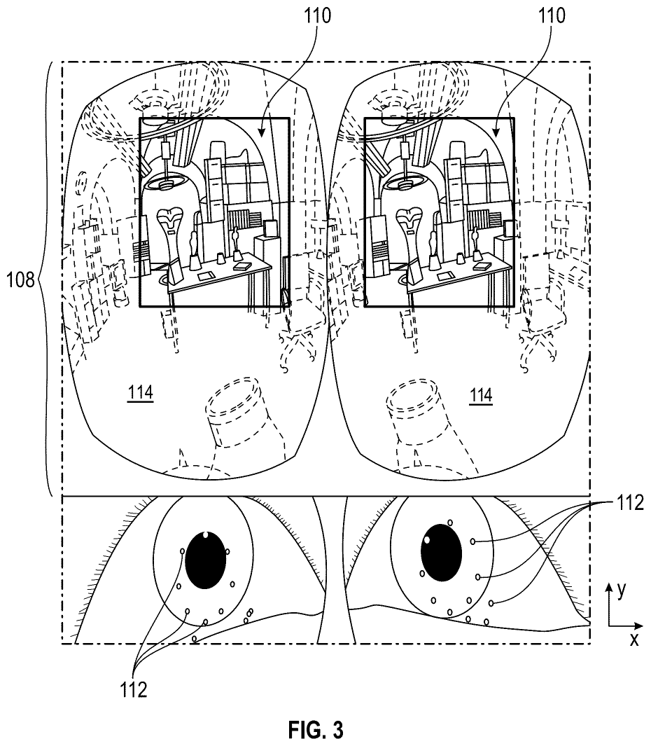

As a further consideration, depth error depends on multiple factors, but mainly on distance. Absolute errors increase with the distance and are in the area of 3 cm below 3 m and 10 cm beyond 3 m. Low resolution of the depth maps plays another role in how users experience occlusions. The applicant's disclosure utilizes gaze information (e.g., eye movement in the field of view) from the user to steer a high-resolution region where enhanced ML based depth from the RGB cameras can be processed. By steering the region of interest (ROI) 108 based on the user's gaze, a higher resolution input and available computation resources can focus on the area the user is looking. During implementation as depicted in FIG. 3, two fidelity levels of depth maps can be generated, including: a low-resolution (QQVGA/QVGA/VGA) depth map 114 can be generated across the entire scene and a high-resolution depth map (HD/2k/3k/4k/8k) 110 in a small region running at a refresh rate of 90 hz. The size of the small high-resolution region 110 can vary depending on the scene specifics. In a further aspect, there can be more than two regions and there can be different frame rates for those regions. For example, the two regions can comprise a QVGA periphery and a full HD fovea region or VGA para-fovea region and full fovea region. Another option would be to have multiple small high-resolution regions that are not based on eye tracking but, e.g., based on where important objects are (e.g., around dynamic objects like hands). For example, in an alternative aspect, a region of interest 108 can also be determined by the movement of the hands using a hand-tracking algorithm.

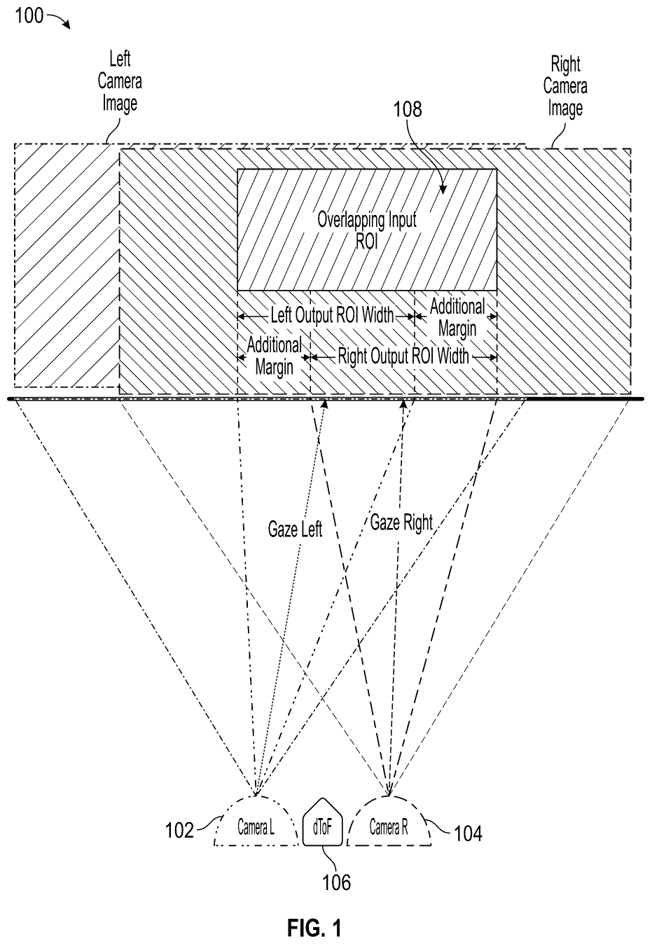

Although the high-resolution output ROI can be quadratic, the input ROIs of the stereo cameras can be rectangular and larger than the output ROI. The closer an object is to the cameras, the larger the disparity/displacement of that object in the two cameras. As the object can be visible in both cameras (ROIs) to estimate depth, as depicted by FIG. 1, the input ROI of the left camera 102 can be extended to the right and the input ROI of the right camera 104 can be extended to the left. For example, the headset implementing a quadratic sensor with parameter settings can comprise 3024×3024 pixels and 122° FoV; further, the 30° (output) ROI can have a size of 744×744 pixels. The disparity of close objects (15 cm) can be approximately ˜356 pixels. Further, the total input ROI would need to have a size of 1100×744 pixels.

As a part of the system implementation in FIG. 1, the system 100 can be initiated by using the gaze signal 112 (x-y spatial coordinates) to steer the ROI of the image. For example, the system can initiate when the system determines that the eye orientation traverses a predetermined x-y coordinate in the virtual space. Steering the overlapping ROI 108 can be controlled in two modes of operation. In the first mode of operation, the system can use a low-resolution full FoV depth sensing. In one aspect, the first mode can be based solely on a depth sensor such as a direct-time-of-flight (dToF) sensor or indirect-time-of-flight (iToF) sensor. In another aspect, the first mode can be based on a fusion of the depth sensor such as a direct-time-of-flight (dToF) sensor or indirect-time-of-flight (iToF) sensor and low-resolution images. In the second mode of operation, the system can implement a foveated full FoV depth sensing at high (display) frequency for passthrough and occlusions. In a further aspect, the second mode can comprise a combination of the first mode for full FoV and high-resolution ROI depth sensing based on the gaze signal (controlled by low-resolution guidance).

In a further aspect, stereo depth estimation works by estimating the disparity between each pixel in one camera to the corresponding pixel of the same feature in the world in the other camera. Disparity can be “converted” into distance. The main challenges presented in a stereo depth estimation can be plain (textureless) areas, repetitive structures, perspective-dependent representations (e.g., specular highlights) and real-world areas that can be seen only in one of the two cameras (occlusions, borders). Artificial Intelligence, machine learning models, and or statistical models can be used to overcome those challenges and output a dense disparity image. In particular, the machine learning models can integrate a direct-time-of-flight (dToF) to measure real radial depth. A dToF sensor 106 works by measuring the outward and return travel of repeated pulses of invisible infrared light which are reflected from objects within the sensor's field of view. In a dToF sensor 106, a light pulse is emitted, triggering a time-to-digital converter (TDC) to initiate. The TDC is used as a stopwatch and when the sensor module's photodetector receives a reflected pulse. The time taken for the emitted pulse to return is stored.

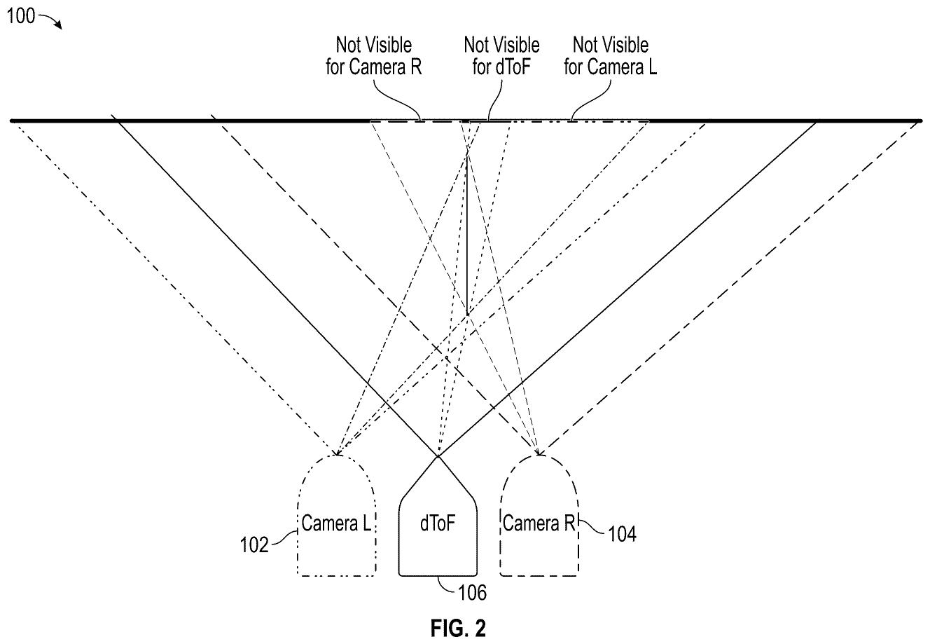

The machine learning depth fusion can be coupled with the dToF in multiple implementations. The fusion aspect of the camera inputs and the dToF takes into account that some areas are not visible for the dToF or some areas dToF sees are not visible for one or both cameras, as depicted in FIG. 2. Raw images can be fed from all sensors into the ML model and learn the correlations between the camera and the low-resolution depth measurements from the dToF sensor. In one aspect, the correlation can comprise converting the dToF depth measurements into disparity information and project them into the individual cameras and use it as additional input layers to the ML model. These input layers to the ML model can comprise four inputs: the left camera image, the disparity from the left dToF, the right camera image, and disparity from the right dToF. In another aspect, the ML model can be derived with the projections determined from the stereo arrangement and integrate the dToF disparity (or even depth) map as a three-dimensional input map to the ML model such that the inputs to the model comprise three inputs: the left camera image, the right camera image and the dToF disparity (depth).

In a second embodiment, dToF generates distance measurements to real objects in the field of view of the user. Each measure point in real space associated with measurement via the dToF sensor 106 can be characterized as a dToF pixel. Every dToF pixel can be projected into any other viewpoint (e.g., into both camera viewpoints). In yet a further aspect, the system can integrate a foveated view 110. For example, as depicted in FIG. 3, the foveated rendering 110 can comprise a high-resolution inner square that can move around based on the user's gaze, and external to the foveated view 110 is a periphery view 114 that comprises a lower resolution. In cases that the gaze signal is not considered sufficiently accurate, or if the system cannot detect any gaze signal, the system can revert back a center-field of view (FoV) high-resolution region of interest (ROI). If a reversion is necessary, the system can still yield higher resolution in the center, which is the most relevant area of the FoV.

The disclosure provides benefits of applying foveation to the depth image generated. In one aspect, the system can utilize lower power consumption while also exhibiting lower latency. In addition, in comparison to the full FoV, the high-resolution ROI is quite small (110°×110° vs. 30°×30°). A smaller high-resolution area spends less computational capacity on a quite small slice of the input data and less compute on more than 90% of the FoV using lower resolution. Further, the system provides more accurate occlusions. In yet a further aspect, the disclosure provides increased performance through increased resolution and compute resources in the ROI comprising: angular resolution, precision, accuracy, and adaptive frame rate per high-resolution region vs. periphery. For example, the refresh rate of the foveated region 110 can be formatted at 72 Hz, 90 Hz or 120 Hz depending on the display capabilities of the headset. The depth frame rate comprising the depth map can be configured to synchronize with the frame rate of the foveated region. High resolution and higher accuracy in the foveated region makes virtual objects more believable in complex MR environments. The periphery views 114 yield good accuracy (due to dToF measurements) but may have lower resolution) (1-2px/°. For example, the frame rate of the periphery view 114 can utilize a frame one-half of the frame rate of the foveated region 110. Further, when temporal consistency is provided, the user experience will not be lowered as the resolution of the eye outside the gaze is low(er) as well.

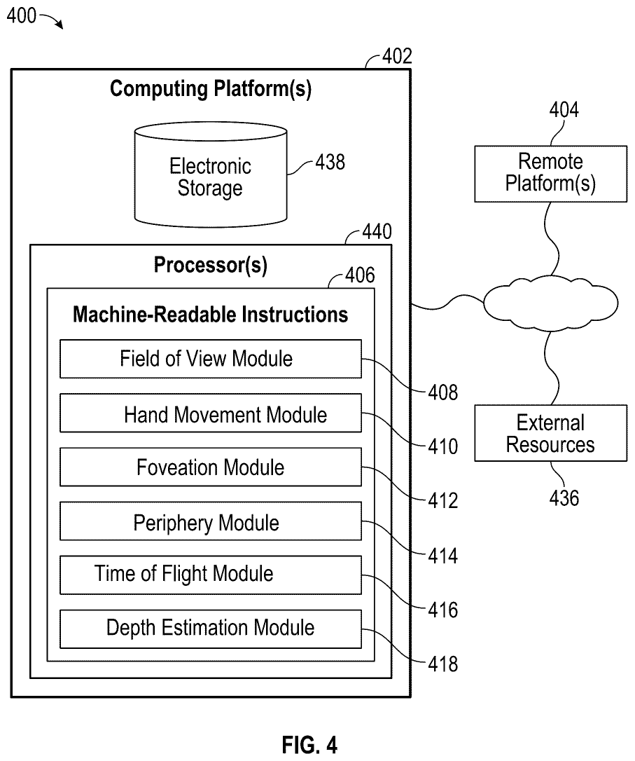

FIG. 4 illustrates a system 400 configured for generating an eye model, in accordance with one or more implementations. In some implementations, system 400 may include one or more computing platforms 402. Computing platform(s) 402 may be configured to communicate with one or more remote platforms 404 according to a client/server architecture, a peer-to-peer architecture, and/or other architectures. Remote platform(s) 404 may be configured to communicate with other remote platforms via computing platform(s) 402 and/or according to a client/server architecture, a peer-to-peer architecture, and/or other architectures. Users may access system 400 via remote platform(s) 404.

Computing platform(s) 402 may be configured by machine-readable instructions 406. Machine-readable instructions 406 may include one or more instruction modules. The instruction modules may include computer program modules. The instruction modules may include one or more of field of view module 408, hand movement module 410, foveation module 412, periphery module 414, time of flight module 416, depth estimation module 418, and/or other instruction modules.

Field of view module 408 may be configured to track, via a wearable device, an eye of a user. In an aspect, the field of view module 408 can be configured to model the shape of the eye and determine the directional movement of the eye. In a further aspect, the field of view module 408 can initiate when the system determines that the eye gaze traverses a predetermined x-y coordinate in the virtual space. The field of view module 408 may also determine the field of view of the eye based on coordinating with cameras 104, 102 (e.g., RGB cameras) oriented external to the wearable device that capture images of an external or virtual scene. The computing platform 402 can also include a hand movement module 410. Similar to a gaze direction derived by the field of view module 408, the hand movement module 410 can detect signals provided by the external cameras 104 and/or external motion sensors (not shown) coupled to a user's hands to determine the spatial orientation for a region of interest defining a depth map.

Foveation module 412 may be configured to generate a high-resolution image from the images captured from the region(s) of interest and the depth estimation module 418. The periphery module 414 may be configured to generate low-resolution images from the images captured from the region(s) of interest and the depth estimation module 418. The time of flight (ToF) module 416 may be configured to determine depth measurements from a depth measurement sensor. In alternative configurations, the depth measurement functionality can comprise a direct Time of Flight, indirect Time of Flight or LiDAR. The depth estimation module 418 can be used in the absence of the time of flight module to estimate distance measurements by using the relationships derived from the disparity parameter associated with the pixels in the images of the regions of interest. The depth estimation module can comprise an artificial intelligence algorithm, machine learning model and/or other statistical model that is trained to increase the accuracy. Similar to the depth estimation module 418, the foveation module 412 and periphery module 414 can comprise an artificial intelligence algorithm, machine learning model and/or other statistical model that can be further trained. For example, the modeling used in the foveation module 412, periphery module 414 and depth estimation module 418 can be trained to manage graphic fidelity to further include resolution and frame rate adjustments based on the underlying system 400 power availability and latency.

In some implementations, computing platform(s) 402, remote platform(s) 404, and/or external resources 436 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 402, remote platform(s) 404, and/or external resources 436 may be operatively linked via some other communication media.

A given remote platform 404 may include one or more processors configured to execute computer program modules. The computer program modules may be configured to enable an expert or user associated with the given remote platform 404 to interface with system 400 and/or external resources 436, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a NetBook, a Smartphone, a gaming console, and/or other computing platforms.

External resources 436 may include sources of information outside of system 400, external entities participating with system 400, and/or other resources. In some implementations, some or all of the functionality attributed herein to external resources 436 may be provided by resources included in system 400.

Computing platform(s) 402 may include electronic storage 438, one or more processors 440, and/or other components. Computing platform(s) 402 may include communication lines, or ports to enable the exchange of information with a network and/or other computing platforms. Illustration of computing platform(s) 402 in FIG. 4 is not intended to be limiting. Computing platform(s) 402 may include a plurality of hardware, software, and/or firmware components operating together to provide the functionality attributed herein to computing platform(s) 402. For example, computing platform(s) 402 may be implemented by a cloud of computing platforms operating together as computing platform(s) 402.

Electronic storage 438 may comprise non-transitory storage media that electronically stores information. The electronic storage media of electronic storage 438 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). Electronic storage 438 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 438 may include one or more virtual storage resources (e.g., cloud storage, a virtual private network, and/or other virtual storage resources). Electronic storage 438 may store software algorithms, information determined by processor(s) 440, information received from computing platform(s) 402, information received from remote platform(s) 404, and/or other information that enables computing platform(s) 402 to function as described herein.

Processor(s) 440 may be configured to provide information processing capabilities in computing platform(s) 402. As such, processor(s) 440 may include one or more of a digital processor, an analog processor, a digital circuit designed to process information, an analog circuit designed to process information, a state machine, and/or other mechanisms for electronically processing information. Although processor(s) 440 is shown in FIG. 4 as a single entity, this is for illustrative purposes only. In some implementations, processor(s) 440 may include a plurality of processing units. These processing units may be physically located within the same device, or processor(s) 440 may represent processing functionality of a plurality of devices operating in coordination. Processor(s) 440 may be configured to execute modules 408, 410, 412, 414, 416, and/or 418 and/or other modules. Processor(s) 440 may be configured to execute modules 408, 410, 412, 414, 416, and/or 418 and/or other modules by software; hardware; firmware; some combination of software, hardware, and/or firmware; and/or other mechanisms for configuring processing capabilities on processor(s) 440. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, 412, 414, 416, and/or 418 are illustrated in FIG. 4 as being implemented within a single processing unit, in implementations in which processor(s) 440 includes multiple processing units, one or more of modules 408, 410, 412, 414, 416, and/or 418 may be implemented remotely from the other modules. The description of the functionality provided by the different modules 408, 410, 412, 414, 416, and/or 418 described below is for illustrative purposes, and is not intended to be limiting, as any of modules 408, 410, 412, 414, 416, and/or 418 may provide more or less functionality than is described. For example, one or more of modules 408, 410, 412, 414, 416, and/or 418 may be eliminated, and some or all of its functionality may be provided by other ones of modules 408, 410, 412, 414, 416, and/or 418. As another example, processor(s) 440 may be configured to execute one or more additional modules that may perform some or all of the functionality attributed below to one of modules 408, 410, 412, 414, 416, and/or 418.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

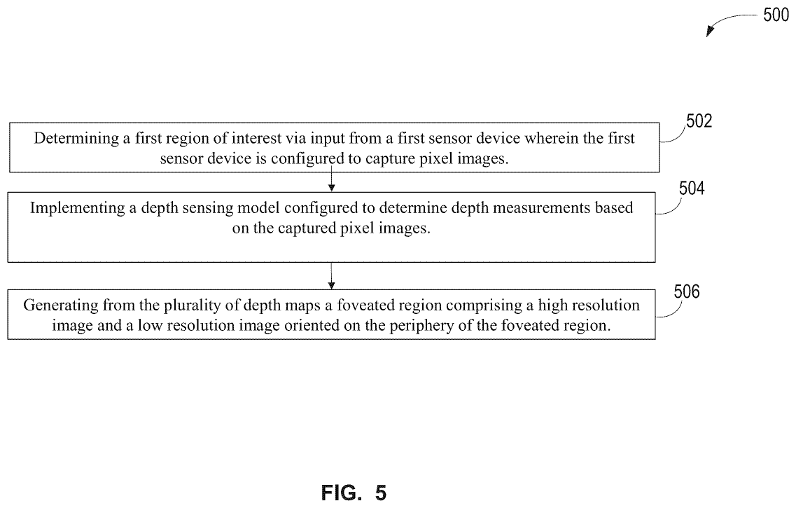

FIG. 5 is an example flow diagram (e.g., process 500) for a generating a dense depth map, according to certain aspects of the disclosure. For explanatory purposes, the example process 500 is described herein with reference to FIG. 5. Further for explanatory purposes, the steps of the example process 500 are described herein as occurring in serial, or linearly. However, multiple instances of the example process 500 may occur in parallel. For purposes of explanation of the subject technology, the process 500 will be discussed in reference to FIG. 5.

At step 502, the process 500 may include determining a first region of interest via input from a first sensor device configured to capture pixel images. At step 504, the process 500 may include implementing a depth sensing model. The depth sensing model can be configured to determine depth measurements based on the captured pixel images. At step 506, the process 500 may include generating from the plurality of depth maps a foveated region comprising a high-resolution image and a low-resolution image oriented on the periphery of the foveated region.

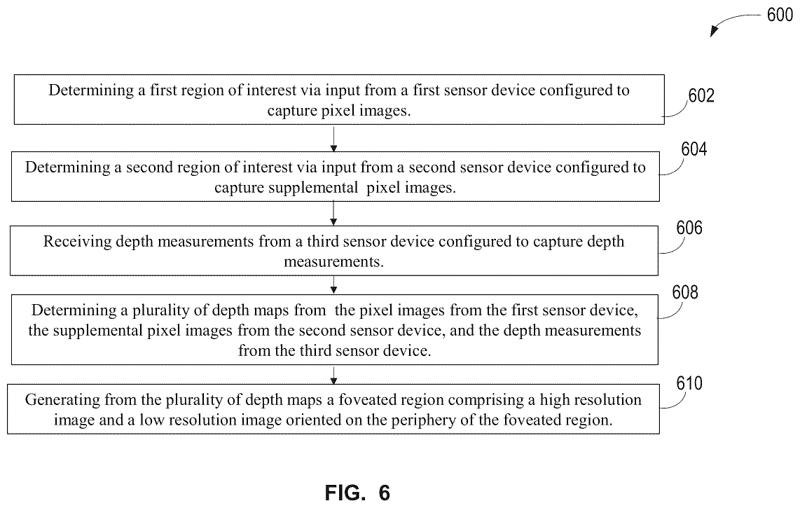

FIG. 6 is an example flow diagram (e.g., process 600) as an alternative embodiment for generating a dense depth map, according to certain aspects of the disclosure. In contrast to the process 500, the process 600 can utilize multiple regions of interest determined from distinct image cameras (e.g., a right camera 102 and a left camera 104), while the process 500 may utilize a single (monocular) image capture approach. Further, the process 600 can utilize a third sensor configured to capture depth measurements, while the process 500 determines depth measurements based on the images captured from the first sensor device.

At step 602, the process 600 may include determining a first region of interest via input from a first sensor device configured to capture pixel images. At step 604, the process 600 may include determining a second region of interest via input from a second sensor device configured to capture supplemental pixel images. At step 606, the process 600 may include receiving depth measurements from a third sensor device configured to capture depth measurements. At step 608, the process 600 may include determining a plurality of depth maps from the pixel images from the first sensor device, the supplemental pixel images from the second sensor device, and the depth measurements from the third sensor device. At step 610, the process 600 may include generating from the plurality of depth maps a foveated region comprising a high-resolution image and a low-resolution image oriented on the periphery of the foveated region.

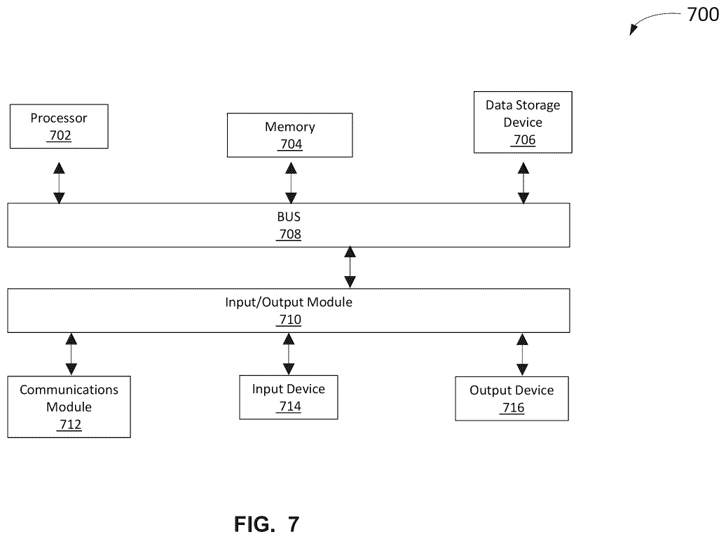

FIG. 7 is a block diagram illustrating an exemplary computer system 700 with which aspects of the subject technology can be implemented. In certain aspects, the computer system 700 may be implemented using hardware or a combination of software and hardware, either in a dedicated server, integrated into another entity, or distributed across multiple entities.

Computer system 700 (e.g., server and/or client) includes a bus 708 or other communication mechanism for communicating information, and a processor 702 coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer-readable medium for execution by, or to control the operation of, the computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, the input/output module 710 is configured to connect to a plurality of devices, such as an input device 714 and/or an output device 716. Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 716 include display devices such as an LCD (liquid crystal display) monitor, for displaying information to the user.

According to one aspect of the present disclosure, the above-described gaming systems can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in the main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 700 reads game data and provides a game, information may be read from the game data and stored in a memory device, such as the memory 704. Additionally, data from the memory 704 servers accessed via a network the bus 708, or the data storage 706 may be read and loaded into the memory 704. Although data is described as being found in the memory 704, it will be understood that data does not have to be stored in the memory 704 and may be stored in other memory accessible to the processor 702 or distributed among several media, such as the data storage 706.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. A method for generating a dense depth map, the method comprising:
determining a first region of interest via input from a first sensor device wherein the first sensor device is configured to capture pixel images;
implementing a depth sensing model configured to:
determine depth measurements based on the captured pixel images; and
generating from the plurality of depth maps a foveated region comprising a high-resolution image and a low-resolution image oriented on the periphery of the foveated region.

2. The method of claim 1, wherein the foveated region is configured to traverse a user field of view and the user field of view is consistent with at least one of: a user eye movement or a user hand movement.

3. The method of claim 1, wherein the depth sensing model is further configured to determine a disparity between each pixel in the first sensor device, wherein the disparity is converted into a depth measurement.

4. The method of claim 1, further comprising determining a second region of interest via a second sensor device, wherein the second sensor device is configured to capture supplemental pixel images, wherein the depth sensing model is further configured to combine a set of the pixel images from the first sensor device, the supplemental pixel images from the second sensor device, and the depth measurements into the plurality of depth maps.

5. The method of claim 1, wherein the plurality of depth maps are configured to implement in a mixed reality environment at least one of: passthrough, dynamic occlusions, boundary defining parameters, or spatial defining parameters.

6. The method of claim 1, wherein generating the foveated region utilizes at least one of:
lower power consumption and lower latency.

7. The method of claim 1, further comprising initiating generation of the high-resolution image or the low-resolution image when the user eye movement or hand movement traverses a predetermined spatial coordinate in a virtual space.

8. The method of claim 1, wherein a first frame rate associated with the low-resolution image is a percentage of a second frame rate associated with the high-resolution image.

9. A system configured for generating a foveated region through eye tracking, the system comprising:
one or more hardware processors configured by machine-readable instructions to:
determine a first region of interest via input from a first sensor device configured to capture pixel images;
determine a second region of interest via input from a second sensor device configured to capture supplemental pixel images;
receive depth measurements from a third sensor device configured to capture depth measurements;
determine a plurality of depth maps from the pixel images from the first sensor device, the supplemental pixel images from the second sensor device, and the depth measurements from the third sensor device; and
generate from the plurality of depth maps a foveated region comprising a high-resolution image and a low-resolution image oriented on the periphery of the foveated region.

10. The system of claim 9, wherein the one or more hardware processors configured by the machine-readable instructions to determine the plurality of depth maps comprises integrating radial depth measurements by projecting the radial depth measurements onto the pixel images and supplemental pixel images.

11. The system of claim 9, wherein the foveated region is configured to traverse a user field of view and is consistent with the user eye movement.

12. The system of claim 9, wherein the one or more hardware processors configured by machine-readable instructions to determine a plurality of depth maps comprises determining a disparity between each pixel in the first sensor device to the corresponding pixel of the same feature in a view of the second sensor device, wherein the disparity is converted into a depth measurement.

13. The system of claim 9, wherein the depth maps are configured to implement in the mixed reality environment at least one of: passthrough, dynamic occlusions, boundary defining parameters, or spatial defining parameters.

14. The system of claim 9, wherein generating the foveated region utilizes lower power consumption and lower latency.

15. The system of claim 9, further configured by the machine-readable instructions to initiate generation of the high-resolution image or the low-resolution image when user eye movement or hand movement traverses a predetermined spatial coordinate in a virtual space.

16. A non-transient computer-readable storage medium having instructions embodied thereon, the instructions being executable by one or more processors to perform a method for generating a foveated region through eye tracking, the method comprising:
determining a first region of interest via input from a first sensor device configured to capture pixel images;
determining a second region of interest via input from a second sensor device configured to capture supplemental pixel images;
receiving depth measurements from a third sensor device configured to capture depth measurements;
determining a plurality of depth maps from the pixel images from the first sensor device, the supplemental pixel images from the second sensor device, and the depth measurements from the third sensor device; and
generating from the plurality of depth maps a foveated region comprising a high-resolution image and a low-resolution image oriented on the periphery of the foveated region.

17. The non-transient computer-readable storage medium of claim 16, wherein the foveated region is configured to traverse a user field of view, wherein the user field of view is consistent with a user eye movement or hand movement.

18. The non-transient computer-readable storage medium of claim 16, wherein determining the plurality of depth maps comprises determining a disparity between each pixel in the first sensor device to the corresponding pixel of the same feature in a view of the second sensor device, wherein the disparity is converted into a depth measurement.

19. The non-transient computer-readable storage medium of claim 16, wherein the depth maps are configured to implement in the mixed reality environment at least one of: passthrough, dynamic occlusions, boundary defining parameters, or spatial defining parameters.

20. The non-transient computer-readable storage medium of claim 16, wherein the depth maps are configured to implement in the mixed reality environment at least one of: passthrough, dynamic occlusions, boundary defining parameters, or spatial defining parameters.
